(19) United States
(12) Patent Application Publication
(10) Pub. No.: US 2016/0241509 A1
(43) Pub. Date: Aug. 18, 2016

(54) Method and System for Integrating On-Premise and Cloud Domain Name Systems

(71) Applicant: Microsoft Technology Licensing, LLC, Redmond, WA (US)

(72) Inventor: MEHMET AKCIN, BOTHELL, WA (US)

(21) Appl. No.: 14/622,911

(22) Filed: Feb. 15, 2015

(51) Int. Cl. H04L 29/12; H04L 29/08

(52) U.S. Cl. CPC H04L 61/1511; H04L 67/10

(57) ABSTRACT

In various embodiments, methods and systems for supporting a domain name system (DNS) using an integrated on-premise-cloud DNS platform are provided. The on-premise-cloud DNS platform supports communication between a cloud DNS server on a cloud computing platform and an on-premise DNS server on an on-premise platform. In operation, the cloud DNS server receives a DNS request from a DNS request-device. The cloud DNS determines that the DNS request is for an on-premise DNS service. An on-premise DNS service can include a policy-based DNS service, a Domain Name Security Extensions (DNSSEC) service, or an Active Directory Service. On-premise services are selectively configured as on-premise services using the on-premise-cloud DNS platform. The DNS request is communicated through a DNS communication channel. Upon the DNS request being processed on the on-premise DNS server, a DNS reply is received through the DNS communication channel and forwarded via the cloud DNS to the DNS request-device.

### BACKGROUND

Cloud computing platforms may offer building, deployment and management functionality for different types of applications and services. In this regard, existing applications or services may be migrated from on-premise systems to cloud computing platforms. Privacy, security, and resiliency of cloud-based support applications and services are a priority to tenants subscribing to cloud computing platforms. As such, the decision to migrate on-premise applications and services to cloud computing platforms can be difficult. In particular, cloud tenants may hesitate, for several different reasons, on moving a master domain naming system (DNS) to cloud computing platforms. Currently, conventional cloud computing platforms are not effective in supporting a domain name system using on-premise DNS servers with support from cloud computing platforms.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the present invention provide methods and systems for integrating on-premise and cloud domain name systems (DNS). An on-premise-cloud DNS platform comprises an end-to-end software framework (e.g., Application Programming Interface—API) that supports an integrated on-premise-cloud DNS platform system. The integrated on-premise-cloud DNS service can be implemented using an on-premise-cloud DNS platform. The on-premise-cloud DNS platform supports communication between a cloud DNS server on a cloud computing platform and an on-premise DNS server on an on-premise platform. In one embodiment, the on-premise-cloud platform implements DNS messaging that circumvents network control units (e.g., firewall, network address translation (NAT), and other network protocols) that control communication with network components. The on-premise-cloud DNS platform may support a DNS communication channel between a cloud-based relay service and an on-premise relay service generated using APIs of the on-premise-cloud DNS platform.

In operation, the cloud DNS server receives a DNS request from a DNS request-device. The cloud DNS server determines whether the DNS request is for an on-premise DNS service. An on-premise DNS service can include a policy-based DNS service, a Domain Name Security Extensions (DNSSEC) service, or an Active Directory Service. On-premise services are selectively configured as on-premise services using the on-premise-cloud DNS platform. The DNS request is communicated through the DNS communication channel. Upon the DNS request being processed on the on-premise DNS server, a DNS reply is received through the DNS communication channel and forwarded from the cloud DNS server to the DNS request-device.

### BRIEF DESCRIPTION OF THE DRAWINGS

The present invention is described in detail below with reference to the attached drawing figures, wherein:

FIG. 1 is a block diagram of an exemplary integrated on-premise-cloud DNS platform operating environment in which embodiments described herein may be employed;

FIG. 2 is a schematic diagram showing a method for providing a DNS using an integrated on-premise-cloud DNS platform, in accordance with embodiments described herein;

FIG. 3 is a flow diagram showing a method for providing a DNS using an integrated on-premise-cloud DNS platform, in accordance with embodiments described herein;

FIG. 4 is a flow diagram showing a method for providing a DNS using an integrated on-premise-cloud DNS platform, in accordance with embodiments described herein; and

FIG. 5 is a block diagram of an exemplary computing environment suitable for use in implementing embodiments described herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising.” In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion below, embodiments of the present invention are described with reference to an on-premise platform and a cloud computing platform; in particular, an API-based implementation of an integrated on-premise-cloud DNS platform will be described. However, the on-premise-cloud DNS platform is merely exemplary implementation and it is contemplated that the techniques described may be extended to other implementation contexts.

A cloud computing platform may span wide geographic locations, including countries and continents. The service and/or application components (e.g., tenant infrastructure or tenancy) of the cloud computing platform may include nodes (e.g., computing devices, processing units, or blades in a server rack) that are allocated to run one or more portions of a tenant's services and applications. When more than one service or application is being supported by the nodes, the nodes may be partitioned into virtual machines or physical machines. The virtual machines or physical machines run each service or application concurrently in individualized computing environments. The computing environments support the resources and/or operating systems specific to each application. Further, each service or application may be divided into functional portions such that each functional portion is able to run on a separate virtual machine or physical machine.

Conventional cloud DNS models have been met with some resistance from tenants of cloud computing platforms, in that, the tenants do not want implement their DNS server (e.g., a master DNS server) on the cloud computing platforms. By way of background, DNS can refer to a hierarchical distributed naming system for computers, services, or any resource connected to the Internet or a private network. At a high level, DNS translates human-friendly computer domain names to numerical IP addresses to support computing services. A DNS server may also interface with several different service and application components that leverage that translation functionality of the DNS server to provide additional functionality.

Privacy, security, and resiliency of cloud-based applications and services are a priority to tenants subscribing to a cloud computing platform, so the decision to migrate an on-premise DNS to a cloud computing platform can be difficult. For example, a bank with sensitive information associated with their DNS may need additional assurance on the ability of the cloud computing platform to keep the information private, secure, and resilient. Also, potential cloud DNS clients can be reluctant to change from an existing DNS deployment with integrated Active Directory, Dynamic Host Configuration Protocol (DHCP) and other services. Tenants may also be reluctant to move DNS servers because poor DNS performance may translate into slow access to web services and unhappy users. Current cloud computing platform DNS implementations have not provided a DNS solution that leverages a cloud computing platform while addressing some of the concerns of tenants, described above.

Embodiments of the present invention provide simple and efficient methods and systems of providing integrated on-premise-cloud DNS platform (“DNS platform”). In particular, an on-premise cloud DNS platform enables cloud computing platform tenants to implement an on-premise DNS that is integrated with a cloud DNS. The DNS platform can be implemented using APIs that support integrating the on-premise DNS with the cloud DNS. Specifically, a master DNS server can be maintained on-premise, to run selectively configured services, while still leveraging resources provided by a cloud DNS on corresponding one or more cloud computing platforms from different cloud DNS providers. In this regard, the integrated on-premise DNS and the cloud DNS can be made available using multiple third-party cloud DNS providers to improve resiliency and adaptability.

DNS platform servers, on-premise or in the cloud, can be specifically implemented using DNS platform components that facilitate messaging for DNS functionality. The components refer to the hardware architecture and software framework that support DNS functionality using the DNS platform. The hardware architecture refers to physical components and interrelationships thereof and the software framework refers to software providing functionality that can be implemented with hardware on a device. Specifically, the hardware architecture may be generic to simplify the functionality described herein using the software framework of the DNS platform. As such, the DNS platform servers can manage resources and provide services at their respective locations to implement functionality of the DNS platform described herein.

In one embodiment, the DNS platform can include an API library that includes specifications for routines, data structures, object classes, and variables may support the interaction of the hardware architecture of servers and the software framework of the DNS platform. These APIs include configuration specifications for the DNS platform such that DNS platform components (e.g., on-premise DNS servers and cloud DNS servers) can communicate with each other in DNS platform system. For example, the DNS platform APIs may support a DNS frontend on the cloud DNS server that facilitates messaging DNS requests and DNS replies with the on-premise DNS server. In this regard, the DNS platform supports an on-premise DNS server, a cloud DNS server having a DNS frontend operably coupled to communicate DNS messages that support the DNS platform functionality. APIs can further support a management interface in the DNS platform to support selectively configuring particular services (e.g., policy-based DNS service, DNSSEC service, or Active Directory) that can be moved maintained on-premise or moved to the cloud DNS.

Communicating DNS messages between the on-premise DNS server and the cloud DNS server can be restricted. For example, an on-premise server and a cloud server in are typically protected by network control units. Network control units refer to hardware or software-based constructs that control communication with network components. For example, firewalls provide network security for controlling incoming and outgoing network traffic by analyzing data packets and determining whether they should be allowed through or not, based on network policies. Similarly NAT is a network protocol that provides IP address information modification while data packets are in transit across a routing device, in order to provide access to particular network components. The network control units (e.g., firewalls and NATs) may impede the ability to communicate DNS requests between on-premise DNS servers and cloud DNS servers.

It is contemplated that embodiments described herein can utilize several different types of messaging protocols (e.g., NAT, PORTS, and VPN) for communicating DNS requests and DNS replies. For example, in a NAT supported platform, a service can be configured with an IP but the service does not have a fixed IP address to expose externally. A port service can also be implemented; however, opening firewall ports to allow access to applications may security concerns in addition to other issues. Further, a solution to build a VPN between the on-premise platform and the cloud computing infrastructure is complicated, in that, if services have to reach multiple cloud DNS servers in different places, multiple VPN connections may be required. Procurement and maintenance of multiple VPNs is expensive. As such, other reliable services (e.g., relay service, queue service described herein) operable concurrently with a plurality of cloud computing platforms can also be implemented using the DNS platform. As such, systems and methods supported by the DNS platform can account for circumventing network control units, and further more efficiently accommodate multiple cloud computing platforms.

In operation, the DNS platform can support a queue, where a queue is a storage service for storing large number of messages (e.g., DNS request). For example, a queue can be accessed from anywhere via authenticated calls using HTTP or HTTPS. In this regard, a queue may be used for DNS messages. Queues are addressable using a URL format. A set of DNS platform APIs may support the implementation of a queue used for DNS messaging. In particular, endpoints and credentials may be configured using a storage connection string for accessing on-premise services. Endpoints in the on-premise platform and in the cloud computing platform may communicate DNS messages to facilitate providing DNS servicer. Queues store DNS messages that may be read by any DNS server (e.g., on premise or cloud) who has access to the queue.

The DNS platform can, in the alternative, support DNS requests using a service bus. A service bus connects local, firewalled on-premise servers and data with cloud DNS without requiring the opening of any inbound ports or otherwise change firewall and router configurations. The DNS platform enables DNS platform components to securely communicate through firewalls by exchanging messages through an endpoint hosted in on-premise or in the cloud. An endpoint refers to an interface through which an individual instance of a service may be accessed. DNS platform APIs facilitate communicating with services binding to the endpoints. Endpoints can be located behind NAT boundaries. In embodiments, relay services as clients in on-premise enterprise networks and a host in the cloud computing platform communicate for DNS messaging. Other variations and combinations of messaging infrastructures of cloud public-messaging infrastructures are contemplated with embodiments of the present invention. In an exemplary embodiment described herein, a DNS hub can be used to receive and relay DNS requests from cloud DNS servers via DNS request-devices (e.g., DNS resolvers and client computing devices) via cloud DNS servers. As such, it is contemplated that embodiments may further support multiple simultaneous cloud DNS providers implemented in a plurality of different locations.

The DNS platform can also support a public rendezvous component, an on-premise relay service, and a cloud relay service. It is contemplated that the on-premise relay and the cloud relay communicate DNS messages using a public rendezvous component. DNS requests can be relayed using the DNS messaging from the cloud DNS server to the on-premise DNS server through a DNS communication channel implemented using relay services and the public rendezvous component. The connection from the relay services to the public rendezvous component may be spontaneous and dynamically generated, such that, DNS messaging from the relay services may circumvent network control units.

Accordingly, in a first aspect of embodiments described herein, a system for implementing integrated on-premise-cloud Domain Name System (DNS) platforms is provided. The system includes a cloud DNS server configured for initializing a DNS communication channel with an on-premise DNS server using an on-premise-cloud DNS platform, wherein the on-premise-cloud DNS platform supports communication between on-premise DNS servers and cloud DNS servers; receiving a DNS request from a DNS request-device; determining that the DNS request is for an on-premise DNS service, wherein the on-premise DNS service is configured as an on-premise service using the on-premise cloud DNS platform; communicating the DNS request through the DNS communication channel; receiving a DNS reply through the DNS communication channel; and forwarding the DNS reply to the DNS request-device.

The system further includes an on-premise DNS server configured for: receiving the DNS request for the on-premise DNS service, wherein the on-premise DNS server supports providing the on-premise DNS service as an integrated on-premise-cloud service based on the on-premise-cloud DNS platform; processing the DNS request using the on-premise DNS service to generate the DNS reply; and communicating the DNS reply using the DNS communication channel.

In a second aspect of embodiment described herein, one or more computer-storage media storing computer-useable instructions that, when used by one or more computing devices, cause the one or more computing devices to perform a implementing integrated on-premise-cloud Domain Name System (DNS) platforms is provided. The method includes initializing a DNS communication channel with an on-premise DNS server using an on-premise-cloud DNS platform. The on-premise-cloud DNS platform supports communication between on-premise DNS servers and cloud DNS servers. The method further includes receiving a DNS request from a DNS request-device. The method also includes determining that the DNS request is for an on-premise DNS service, wherein the on-premise DNS service is configured as an on-premise service using the on-premise cloud DNS platform. The method includes communicating the DNS request through the DNS communication channel. The method also includes receiving a DNS reply through the DNS communication channel and forwarding the DNS reply to the DNS request-device.

In a third aspect of the present invention, a computer-implemented method for implementing integrated on-premise-cloud Domain Name System (DNS) platforms is provided. The method includes receiving a DNS request for an on-premise DNS service. The on-premise DNS server supports an on-premise DNS service as an integrated on-premise-cloud service based on a on-premise-cloud DNS platform. The method also includes processing the DNS request using the on-premise DNS service to generate the DNS reply. The method includes communicating the DNS reply using the DNS communication channel.

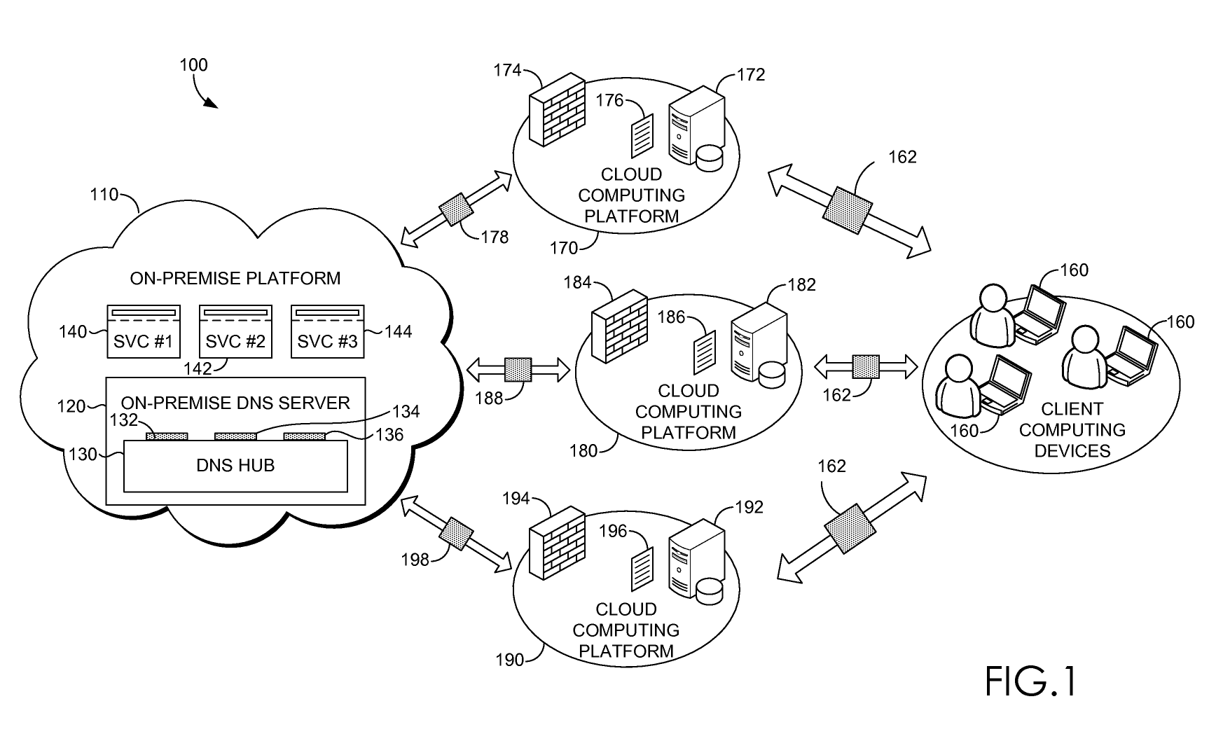

With reference to FIG. 1, a block diagram of an exemplary on-premise-cloud DNS platform system 100 in an operating environment suitable for use in embodiments of the invention is described. Generally, the on-premise-cloud DNS platform system 100 (“DNS platform system 100”) illustrates an environment for supporting integrated on-premise-cloud DNS messaging using an on-premise-cloud DNS platform (“DNS platform”). Embodiments described herein also provide a system and method of providing integrated on-premise-cloud DNS using different cloud DNS providers supporting multiple deployments of cloud DNS in corresponding cloud computing platforms using the on-premise-cloud DNS platform. Among other components not shown, the on-premise-cloud DNS platform system 100 generally includes an on-premise platform 110, on-premise DNS server 120 having a DNS hub, on-premise services 140, 142, 144, client computing device 160, cloud computing platforms 170, 180, 190, cloud DNS servers 172, 182, 192, all in communication with one another via a network (not shown).

With continued reference to FIG. 1, the network may include, without limitation, one or more local area networks (LANs) and/or wide area networks (WANs). Such networking environments are commonplace in offices, enterprise-wide computer networks, intranets and the Internet. The on-premise platform 110 and the cloud computing platforms 170, 180, 190 may each include several components (not shown) for supporting services and applications in each or both platforms. For example, components that facilitate on-premise DNS services on an on-premise DNS server through a cloud DNS server. The types of on-premise DNS services and cloud DNS services described herein that are supported on these platforms are not intended to limit the scope of embodiments of the present invention in any way. Components of the on-premise-cloud DNS platform system 100 may be linked together by the network backbone spanning to multiple cloud computing platforms each supporting a cloud DNS service.

In some embodiments, one or more of the illustrated components/modules may be implemented as stand-alone applications. Any number of client computing devices 160 (e.g., DNS resolver, DNS request-device), on-premise DNS server 120, cloud DNS servers 172, 182, 192, on-premise platform 110, and cloud computing platforms 170, 180, 190, may be employed in the DNS platform system 100 within the scope of embodiments of the present invention. Each may comprise a single device/interface or multiple devices/interfaces cooperating in a distributed environment. For instance, the on-premise platform 110 may comprise multiple devices and/or modules arranged in a distributed environment that collectively provide the functionality of the on-premise platform 110 described herein.

As used herein, the phrase “on-premise platform” or “cloud computing platform” is not meant to be limiting, but may encompass a number of applications and services on a private and public networks respectively that facilitate DNS communications between an on-premise DNS server and a cloud DNS server. Additionally, other components/modules not shown also may be included within the cloud computing platforms 170, 180, 190 and the on-premise platform 110. For example, the cloud computing platforms 170, 180, 190 are configured to allocate virtual machines within a data center for use by a service application. The cloud computing platforms 170, 180, 190 also may be a public cloud, a private cloud, or a dedicated cloud. The cloud computing platforms 170, 180, 190 may include a data center configured to host and support operation of endpoints in a particular service application. The phrase “application” or “service” as used herein broadly refers to any software, or portions of software, that run on top of, or accesses storage locations within, the datacenter. In one embodiment, one or more of the endpoints may represent the portions of software, component programs, or instances of roles that participate in the service or application.

It should be understood that this and other arrangements described herein are set forth only as examples. Other arrangements and elements (e.g., machines, interfaces, functions, orders, and groupings of functions) can be used in addition to or instead of those shown, and some elements may be omitted all together. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

With continued reference to FIG. 1, a cloud computing platform (e.g., cloud computing platforms 170, 180, 190) acts to store data or run services and applications (not shown) in a distributed manner. The cloud computing platforms 170, 180, 190 are further configured to deploy, manage, monitor and maintain several different types of components. For instance, the cloud computing platforms 170, 180, 190 function to run one or more portions of tenants' applications (e.g., a cloud DNS 172, 182, 192). The cloud computing platforms 170, 180, 190 include cloud DNS servers 172, 182, 192 to facilitate DNS communications.

The DNS platform can support a DNS frontend 176, 186, 196 that facilitates communication between a cloud computing platform and an on-premise platform. The DNS platform may support a DNS frontend that allows cloud DNS server (e.g., cloud DNS servers 172, 182, 192) to communicate via the DNS messaging with on-premise platform 110 components. A DNS platform may circumvent network control units by communicating using the application layer, as described herein.

With continued reference to FIG. 1, FIG. 1 illustrates an on-premise platform 110 having an on-premise DNS server 220 with a DNS hub 230, and on-premise services 140, 142, 144. The on-premise platform can be implemented a cloud computing platform supporting cloud functionality described herein. Additionally, and in the alternative, the on-premise platform may be implemented with DNS platform APIs to support DNS messaging for the DNS platform system. In particular, the on-premise platform can support an on-premise DNS server 120 that is generally configured for performing DNS functionality and specifically support DNS services that have been selectively configured for integrated on-premise-cloud functionality. The on-premise DNS server 120 supports DNS functionality based on DNS requests 178, 188, 198 sent from cloud DNS servers 172, 182, 192 and processes the DNS requests to generate DNS replies 178, 188, 198 that are communicated to the cloud DNS servers and client computing devices 160.

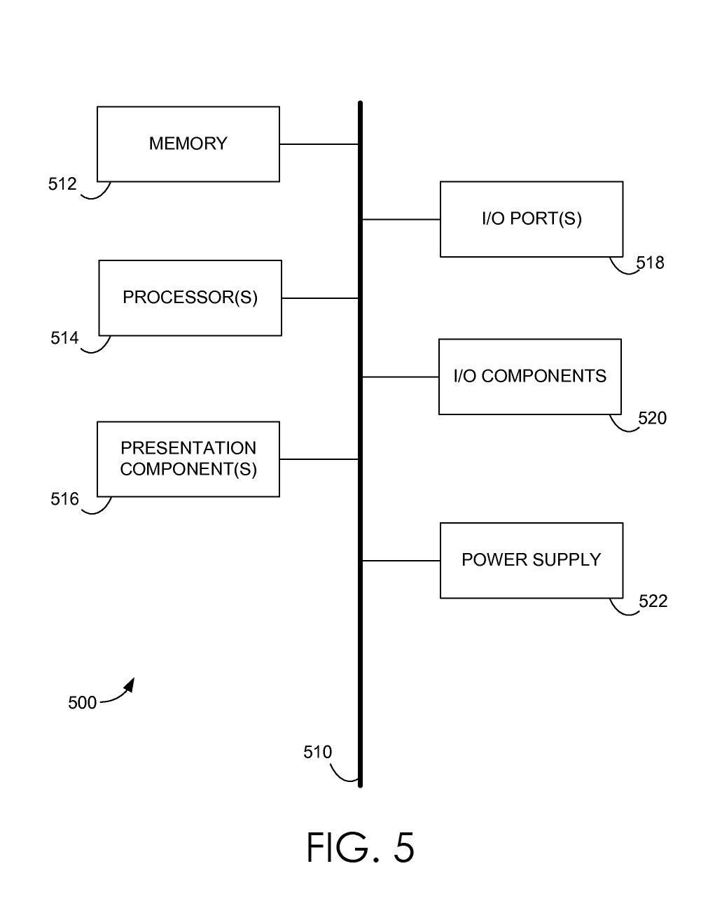

DNS requests 178, 188, 198 and DNS replies 178, 188, 198 replies can correspond to client computing devices 160. Client computing devices 160 (e.g., DNS resolver DNS request-device) may include any type of computing device, such as the computing device 500 described with reference to FIG. 5, for example. The client computing devices 160 may be used directly by users to communicate via cloud computing platforms 170, 180, and 190. The client computing devices 160 can send DNS requests 162 to a cloud computing platform and receive DNS replies 162 via the cloud computing platform from on-premise DNS services 140, 142, 144 running on the on-premise platform 110. It is contemplated that the client computing devices 160 can generate a DNS request 162 that is processed based on functionality described herein. For example, the client computing devices 160 may communicate a DNS request 162 to a cloud DNS in a cloud computing platform. DNS messaging can be triggered on the cloud DNS, upon the client computing devices 160 communicating a DNS request 162 that is to be processed using at least one of the on-premise services 140, 142, 144.

In operation, a cloud DNS server receives a DNS request 162 from cloud computing devices and an on-premise service communicates DNS replies 178, 188, 198 through the on-premise DNS server 120 in response to DNS requests from client computing devices. DNS requests can be specifically communicated through a cloud DNS server to on-premise services 140, 142, 144 in the on-premise platform. The DNS request may be generated based on client computing devices 160 communications to the cloud DNS server 172, 182, 192. The cloud DNS server can determine that the DNS request corresponds to an on-premise DNS service. An on-premise DNS service can be one of a policy-based DNS service, a DNSSEC service, or an Active Directory Service. A DNS reply is based on a corresponding on-premise DNS service evaluating the DNS request and communicating with the on-premise DNS service to generate the DNS reply. It is contemplated that the DNS platform may support operations on the on-premise DNS server while excluding any changes to the corresponding services implemented on-premise.

The on-premise DNS platform 110 can support different types of on-premise DNS services 140, 142, 144. A policy-based DNS service can refer to DNS functionality that corresponds to action to be taken when on-premise service query element is met in a DNS request. A DNS request can include the following request elements: specified DNS domain name, a query type, or a class for the DNS domain. Name. The policy can be associated with a specific request element such that when a request element is encountered the cloud DNS server makes a determination to forward the DNS request to the on-premise DNS service corresponding to the DNS request to resolve the DNS request and generate a DNS reply to the DNS request.

Embodiments described herein can specifically configure the cloud DNS server and the on-premise DNS server to process DNS requests that operate under additional security protection. A DNSSEC service on the on-premise DNS server is designed to protect client computing devices from using forged or manipulated DNS data that can be created DNS cache poisoning. The DNS replies from a DNSSEC protected zone are digitally signed to demonstrate the authenticity of the DNS messages. By checking the digital signature a DNS resolver is able to verify the authenticity of the DNS reply. In this regard, the on-premise DNS server (e.g., a master DNS server) can maintain a DNSSEC service on the on-premise DNS platform and support the functionality using the on-premise DNSSEC service and not have to move components of the DNSSEC service to the cloud DNS server in the cloud computing platform.

An on-premise platform can also implement an Active Directory service that can operate based on the DNS platform. Active Directory (AD) refers to a directory service the functions with a domain controller to authenticate and authorize users and computers. AD can assign and enforce policies for specific computers and users on a network. AD can depend on DNS in that a domain controller location mechanism of AD uses DNS name conventions in the perform AD tasks. The DNS platform can configure the DNS platform system such that the AD is maintained on-premise and the AD functionality is performed with the on-premise DNS server and communicated via the cloud DNS to a client computing device. In operation, a DNS request corresponding to an AD operation can be received at the cloud DNS server, and upon the cloud DNS making a determination that the DNS request is for an AD operation, the cloud DNS can communicate the request to the on-premise DNS server using a DNS communication channel as described herein. The on-premise DNS server receives the DNS request and communicates with the AD service to generate a DNS reply which is communicated using the DNS communication channel via the cloud DNS server to the client computing device making the request. In this regard, a tenant of the cloud DNS can still maintain on-premise AD service for improved privacy, security, and resiliency. Other variations and combination of on-premise DNS services are contemplated with embodiments described herein.

The on-premise platform server 120 and the cloud DNS servers 172, 182, 192 implement DNS platform APIs that allow communication of DNS requests and DNS replies. In this regard, implementing the on-premise DNS server 120 may be accomplished while excluding any changes to on-premise service 140, 142, and 144. For example, the services and on-premise DNS servers communicate as usual while the DNS platform APIs execute steps to facilitate on-premise-cloud DNS.

The on-premise DNS server 120 also functions as a DNS hub 130, using DNS messaging to receive and relay DNS requests from cloud DNS servers to on-premise DNS services. For example, the DNS hub may receive individual DNS requests for each on-premise DNS service based on DNS communication channels 132, 134, 136. It is contemplated that each DNS communication channel may correspond to a particular service. In the alternative, a DNS communication channel may exist such that each service pulls a DNS message from the DNS communication channel that corresponds to the service. DNS messaging using the on-premise DNS server and the cloud DNS server may be implemented using the DNS hub 130 and a routing service that establishes an outgoing-coming connection through a DNS communication channel such that the DNS requests are allowed to circumvent network control units (e.g., network control units 174, 184, 194). Network control units can be implemented on the on-premise platform and or the cloud computing platform. Network control units, by way of example, include firewalls and NAT protocols that would otherwise prevent communication with the cloud DNS servers 172, 182, 192. As such, the DNS hub supports multiple and simultaneous DNS communication channels with which a plurality of DNS request from cloud DNS servers that may be implemented in a plurality of different locations.

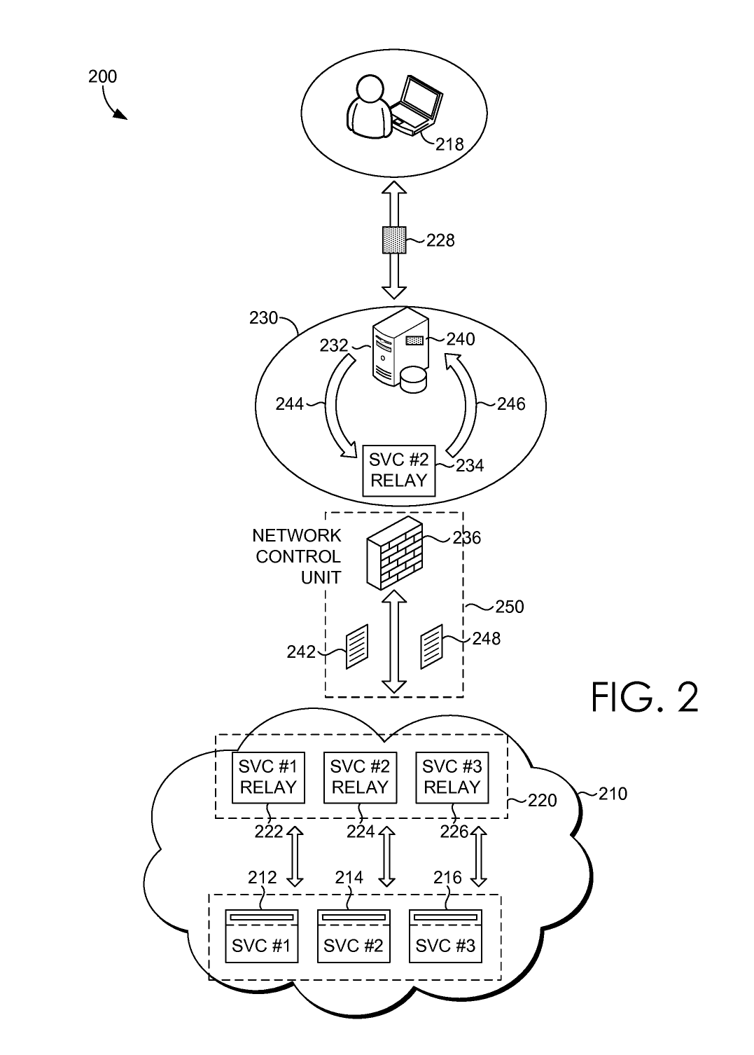

With reference to FIG. 2, an exemplary relay-based illustration of a method for DNS messaging using the DNS platform is provided. In particular, DNS messaging may be implemented for supporting a plurality of on-premise services (e.g., on-premise services 212, 214, 216) in conjunction with the on-premise DNS platform 210. A client computing device 218 may generate a DNS request that corresponds to one of the on-premise service 212, 214, 216. The cloud DNS server 232 is configured to make a determination that a DNS request 228 corresponds to an on-premise DNS service and communicate 244 the DNS request 228 using a DNS communication channel 350 to the on-premise DNS platform for processing. In this regard, DNS platform may include components in both a cloud computing platform and an on-premise platform that facilitate DNS messaging. In particular, specific on-premise service 212, 214, 216 can be selectively configured using the DNS platform for processing on an on-premise DNS server and not the cloud DNS server. In embodiments, the cloud DNS server 232 comprises a DNS frontend (not shown) that facilitates communication between platforms. In particular, the DNS frontend allows on-premise components (e.g., on-premise DNS server) to communicate via DNS messaging with cloud computing platform components.

DNS platform may support the on-premise DNS server 220 function as a DNS hub in that the on-premise DNS server accesses a DNS communications channel 250 and receives DNS requests 242 of different cloud computing platform to service multiple deployments of different cloud DNS servers. Specifically, the on-premise DNS server 220 functioning as a DNS hub supports a plurality of DNS communication relay channels (e.g., relay channels 222, 224, 226) for the on-premise DNS services. For example, the cloud DNS server 320 generates a DNS communication channel 250 for DNS messaging between services 222, 224, 226 and a cloud DNS server 232. The DNS communication channel 250 between the cloud DNS server 232 and an on-premise DNS service 214 supports DNS messages communicated through the DNS communication channel 250 while circumventing network control units (e.g., network control unit 236) associated with one or both of the on-premise platform 210 of the on-premise DNS server 220 and a cloud-computing platform 230 of the cloud DNS server 232. It is contemplated that the client computing device 218 triggers DNS messaging of a DNS request 228 for receiving 246 a DNS reply 248 to the DNS request 228 through the cloud DNS server.

In an exemplary embodiment, a cloud relay service (e.g., app #2 relay service 224) and an on-premise relay service (e.g., app #2 relay service 234) are used in generating the DNS communication channels. Upon initializing the DNS communication channel 250, the relay service 224 may open a port 240 (e.g., User Datagram Protocol (UDP) port or a Transmission Control Protocol) in the cloud DNS server to listen for requests from the client computing device. The port 240 may remain active for listening for a predetermined period of time, or it may be open and closed based on a predetermined trigger. Other variations and combinations of initializing and terminating listening on the port 240 are contemplated with embodiments of the present invention. It is further contemplated that a plurality of relay channels may be configured to support corresponding services.

The cloud DNS server can function as a DNS frontend to facilitate communication between the cloud computing platform components and the on-premise platform components. Upon receiving a DNS request 228 from a cloud computing device, the cloud DNS server can determine the DNS request corresponds to an on-premise service that is maintained on an on-premise platform for processing therein. The cloud DNS server communicates 244 the DNS request 228 to the cloud service relay 234. The relay service 234 pushes the DNS request to on-premise DNS platform 210. The DNS platform can implement a public rendezvous component that is a public available medium for communicating DNS messages. The on-premise relay service 224 pulls from the DNS frontend through the DNS communication channel, the DNS request 242 circumventing the network control unit 236. The on-premise DNS server 220 communicates a DNS reply 248 to the DNS request 242 via the cloud relay service 234. The reply 248 may is based on the on-premise service 214 processing the DNS request 242. The cloud relay service 234 receives the reply 248 to the DNS request through DNS communication channel 250 and communicates 246 the reply 248 to the cloud DNS server 232. The cloud DNS server 232 then forwards the DNS reply 228 to the client computing device 218.

In another exemplary embodiment, the DNS platform may be implemented, by way of example, as a queue. A queue is a storage service for storing large number of messages. For example, a queue can be accessed from anywhere via authenticated calls using HTTP or HTTPS. In this regard, a queue may be used for DNS messaging. Queues are addressable using a URL format. A set of APIs (e.g., Representation State Transfer (“REST”) APIs) may support the implementation of a queue used for DNS messaging. In particular, endpoints and credentials may be configured using a storage connection string for accessing on-premise services. Endpoints in the on-premise platform and in the cloud-computing platform may communicate DNS messages to facilitate maintain master DNS server functionality on-premise while leveraging resources on one or more cloud computing platform cloud DNS service. A queue may be used as the DNS platform for transferring messages between services. Queues store DNS messages (e.g., DNS requests) that may be received from any cloud computing platform and read at the on-premise platform that has access to the queue storage account.

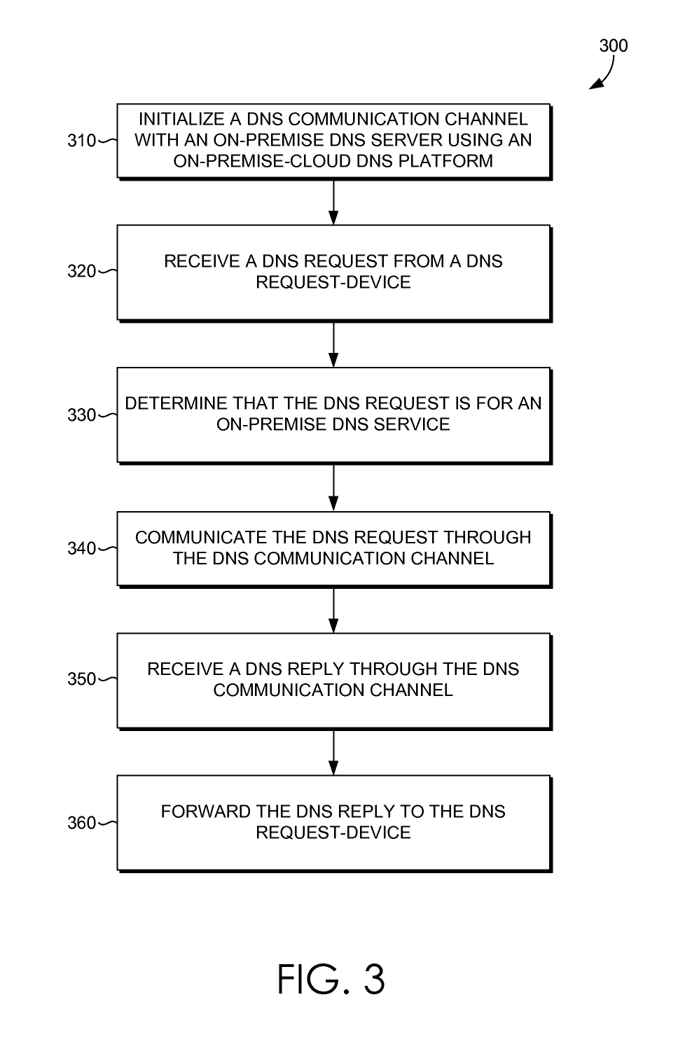

Turning now to FIG. 3, a flow diagram is provided that illustrates a method 300 for implementing integrated on-premise-cloud Domain Name System (DNS) platforms. Initially at block 310, a DNS communication channel with an on-premise DNS server using a on-premise-cloud DNS platform is initialized. The on-premise-cloud DNS platform supports communication between on-premise DNS servers and cloud DNS servers. At block 320 a DNS request from a DNS request-device is received. At block 330, a determination is made that the DNS request is for an on-premise DNS service. The on-premise DNS service is configured as an on-premise service using the on-premise cloud DNS platform. At block 340, the DNS request is communicated through the DNS communication channel. At block 350, a DNS reply is received through the DNS communication channel. At block 360, the DNS reply is forwarded to the DNS request-device.

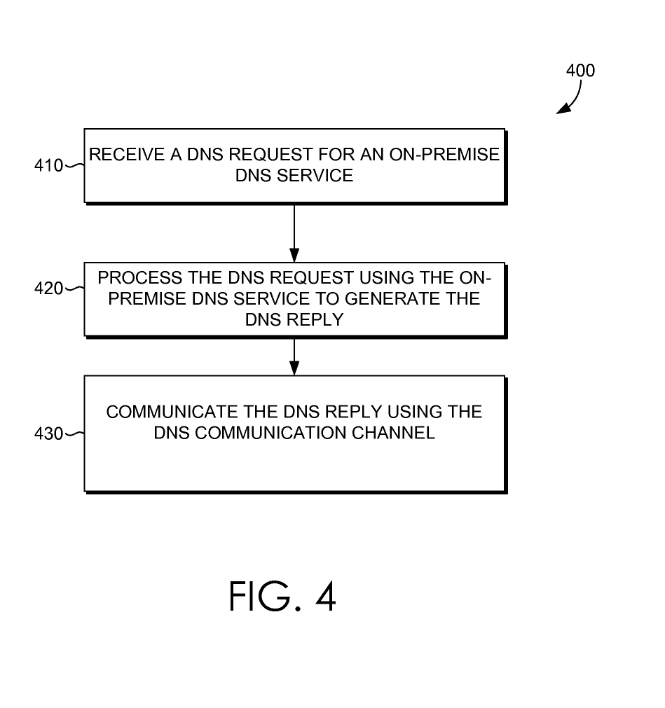

Turning now to FIG. 4, a flow diagram is provided that illustrates a method 400 for implementing integrated on-premise-cloud Domain Name System (DNS) platforms. Initially at block 410, a DNS request for an on-premise DNS service is received. The on-premise DNS server supports an on-premise DNS service as an integrated on-premise-cloud service based on a on-premise-cloud DNS platform. At block 420, the DNS request is processed using the on-premise DNS service to generate the DNS reply. At block 430, the DNS reply using the DNS communication channel is communicated.

Having briefly described an overview of embodiments of the present invention, an exemplary operating environment in which embodiments of the present invention may be implemented is described below in order to provide a general context for various aspects of the present invention. Referring initially to FIG. 5 in particular, an exemplary operating environment for implementing embodiments of the present invention is shown and designated generally as computing device 500. Computing device 500 is but one example of a suitable computing environment and is not intended to suggest any limitation as to the scope of use or functionality of the invention. Neither should the computing device 500 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 5, computing device 500 includes a bus 510 that directly or indirectly couples the following devices: memory 512, one or more processors 514, one or more presentation components 516, input/output ports 518, input/output components 520, and an illustrative power supply 522. Bus 510 represents what may be one or more busses (such as an address bus, data bus, or combination thereof). Although the various blocks of FIG. 5 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 5 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 5 and reference to “computing device.”

Computing device 500 typically includes a variety of computer-readable media. Computer-readable media can be any available media that can be accessed by computing device 500 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 512 includes computer storage media in the form of volatile and/or nonvolatile memory. The memory may be removable, non-removable, or a combination thereof. Exemplary hardware devices include solid-state memory, hard drives, optical-disc drives, etc. Computing device 500 includes one or more processors that read data from various entities such as memory 512 or I/O components 520. Presentation component(s) 516 present data indications to a user or other device. Exemplary presentation components include a display device, speaker, printing component, vibrating component, etc.

I/O ports 518 allow computing device 500 to be logically coupled to other devices including I/O components 520, some of which may be built in. Illustrative components include a microphone, joystick, game pad, satellite dish, scanner, printer, wireless device, etc.

Embodiments presented herein have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention in one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

The invention claimed is:

1. A system for implementing integrated on-premise-cloud Domain Name System (DNS) platforms, the system comprising:
a cloud DNS server configured for:
initializing a DNS communication channel with an on-premise DNS server using an on-premise-cloud DNS platform, wherein the on-premise-cloud DNS platform supports communication between on-premise DNS servers and cloud DNS servers;
receiving a DNS request from a DNS request-device;
determining that the DNS request is for an on-premise DNS service, wherein the on-premise DNS service is configured as an on-premise service using the on-premise cloud DNS platform;
communicating the DNS request through the DNS communication channel;
receiving a DNS reply through the DNS communication channel; and
forwarding the DNS reply to the DNS request-device; and
an on-premise DNS server configured for:
receiving the DNS request for the on-premise DNS service, wherein the on-premise DNS server supports providing the on-premise DNS service as an integrated on-premise-cloud service based on the on-premise-cloud DNS platform;
processing the DNS request using the on-premise DNS service to generate the DNS reply; and
communicating the DNS reply using the DNS communication channel.

2. The system of claim 1, further comprising the on-premise DNS server configured for:
accessing a plurality of DNS requests in a DNS hub, wherein the DNS hub comprises a plurality of DNS communication channels for a plurality of cloud DNS servers in cloud computing platforms.

3. The system of claim 1, wherein the on-premise DNS server is further configured for accessing the plurality of DNS requests from the plurality of cloud DNS servers, wherein cloud DNS servers are simultaneously operated by different cloud DNS service providers.

4. The system of claim 1, wherein the on-premise-cloud DNS platform comprises application programming interfaces (“APIs”) that are compatible with an existing on-premise DNS system such that the on-premise-cloud DNS platform operates with existing on-premise DNS services.

5. The system of claim 1, wherein the on-premise-cloud DNS platform comprises a service bus, wherein the service bus supports DNS messaging using binding of corresponding on-premise-cloud DNS APIs implemented using an on-premise-relay service and a cloud-relay service respectively.

6. The system of claim 5, wherein binding is supported by endpoints located behind network control units.

7. The system of claim 1, wherein the on-premise-cloud DNS platform comprises a queue, wherein the queue supports DNS messaging for on-premise DNS service operations.

8. The system of claim 1, wherein an on-premise service comprises at least one of: a policy-based cloud service, a Domain Name Security Extensions (DNSSEC) service or an Active Directory Service, wherein the on-premise service is selectively configured as an integrated on-premise-cloud service using the on-premise-cloud DNS platform.

9. One or more computer-storage media storing computer-useable instructions that, when used by one or more computing devices, cause the one or more computing devices to perform a method for implementing integrated on-premise-cloud Domain Name System (DNS) platforms, the method comprising:
initializing a DNS communication channel with an on-premise DNS server using a on-premise-cloud DNS platform, wherein the on-premise-cloud DNS platform supports communication between on-premise DNS servers and cloud DNS servers;
receiving a DNS request from a DNS request-device;
determining that the DNS request is for an on-premise DNS service, wherein the on-premise DNS service is configured as an on-premise service using the on-premise cloud DNS platform;
communicating the DNS request through the DNS communication channel;
receiving a DNS reply through the DNS communication channel; and
forwarding the DNS reply to the DNS request-device.

10. The media of claim 9, wherein upon initializing a DNS communication channel, opening a port in on a cloud DNS server to listen for DNS requests from the DNS request-device.

11. The media of claim 9, wherein determining that the DNS request is for an on-premise DNS service further comprises identifying that the DNS request corresponds to at least one of: a policy-based cloud service, a Domain Name Security Extensions (DNSSEC) service or an Active Directory Service, wherein the on-premise service is selectively configured as an integrated on-premise-cloud service using the on-premise-cloud DNS platform.

12. The media of claim 9, wherein the on-premise-cloud DNS platform provides connectivity through the DNS communication channel between the on-premise DNS server and a cloud DNS server such that DNS request is communicated through the DNS communication channel while circumventing network control unit boundaries associated with an on-premise platform of the on-premise DNS server and a cloud computing platform of the cloud DNS server.

13. The media of claim 9, communicating the DNS request through the DNS communication channel is performed using a DNS frontend, wherein the DNS front end implements a public rendezvous component for exchanging DNS messages.

14. The media of claim 3, further comprising transmitting the DNS request via a DNS hub, wherein the DNS hub comprises a plurality of DNS communication channels for a plurality of cloud DNS servers in cloud computing platforms.

15. A computer-implemented method for implementing integrated on-premise-cloud Domain Name System (DNS) platforms, the method comprising
receiving a DNS request for an on-premise DNS service, wherein the on-premise DNS server supports an on-premise DNS service as an integrated on-premise-cloud service based on a on-premise-cloud DNS platform;
processing the DNS request using the on-premise DNS service to generate the DNS reply; and
communicating the DNS reply using the DNS communication channel.

16. The method of claim 15, wherein receiving the DNS request is based on an on-premise relay service and a cloud-based relay service.

17. The method of claim 15, wherein the DNS requests circumvent network control unit boundaries associated with an on-premise platform of the on-premise DNS server and a cloud computing platform of the cloud DNS server.

18. The method of claim 15, wherein receiving the DNS request is based on an on-premise-cloud DNS platform queue, wherein the queue supports DNS messaging for on-premise DNS services.

19. The method of claim 15, wherein an on-premise service comprises at least one of: a policy-based cloud service, a Domain Name Security Extensions (DNSSEC) service or an Active Directory Service, wherein the on-premise service is selectively configured as an integrated on-premise-cloud service using the on-premise-cloud DNS platform.

20. The method of claim 3, further comprising accessing a plurality of DNS requests in a DNS hub, wherein the DNS hub comprises a plurality of DNS communication channels for a plurality of cloud DNS servers in cloud computing platforms.
